(19) United States
(12) Patent Application Publication
(10) Pub. No.: US 2024/0067048 A1
(43) Pub. Date: Feb. 29, 2024

(54) AUTOMOTIVE BATTERY SYSTEM

(71) Applicant: TOYOTA JIDOSHA KABUSHIKI KAISHA, Aichi-ken (JP)

(72) Inventor: YU HOSHINO, Toyota-shi (JP)

(21) Appl. No.: 18/454,075

(22) Filed: Aug. 23, 2023

(30) Foreign Application Priority Data
Aug. 31, 2022 (JP) 2022-137465

(51) Int. Cl. B60L 58/25; B60H 1/00; B60K 11/02; B60L 3/06; B60L 50/60; H01M 10/48; H01M 10/613; H01M 10/625; H01M 10/635; H01M 10/6568; H01M 10/663

(52) U.S. Cl. CPC B60L 58/25; B60H 1/00278; B60K 11/02; B60L 3/06; B60L 50/60; H01M 10/486; H01M 10/613; H01M 10/625; H01M 10/635; H01M 10/6568; H01M 10/663; B60H 2001/00307; B60L 2240/12; B60L 2240/545; B60L 2250/28; H01M 2220/20

(57) ABSTRACT

When the temperature of a battery is high, the output power of the battery is limited to suppress the temperature rise. Upon fulfillment of three conditions of (i) the ambient temperature is equal to or higher than a predetermined temperature, (ii) the vehicle traveling load is equal to or greater than a predetermined traveling load, and (iii) the operating load of a battery cooling device is equal to or greater than a predetermined operating load, the output power of the battery is limited using a high-load output limiting value less than an output limiting value for the normal condition in a temperature range equal to or higher than a second power restrictive lower limit temperature that is equal to or lower than a first power restrictive lower limit temperature for the normal condition.

### CROSS REFERENCE TO RELATED APPLICATION

This application claims priority to Japanese Patent Application No. 2022-137465 filed on Aug. 31, 2022 which is incorporated herein by reference in its entirety including the specification, claims, drawings, and abstract.

### TECHNICAL FIELD

The present disclosure relates to an automotive battery system that supplies electric power to an electric motor that drives a vehicle, and more particularly relates to cooling of a battery.

### BACKGROUND

Electric vehicles provided with electric motors for driving the vehicles are conventionally known. The electric vehicles include battery electric vehicles that use only the power of electric motors for driving the vehicles, and hybrid electric vehicles that use the combined power of electric motors and engines for driving the vehicles. The electric vehicles include batteries mounted for supplying electric power to electric motors to drive the vehicles. The batteries are restricted by a workable upper limit temperature, for protection of the batteries. There is a known technique for suppressing the battery temperature rise by limiting the electric power output from the battery so as not to exceed the workable upper limit temperature, when the battery temperature comes close to the workable upper limit temperature. JP 11-224697 A discloses a technique for changing the battery temperature, in which the restriction of output power is started according to the depth of discharge; that is, the value obtained by subtracting the current power storage amount from the fully charged power storage amount.

When the traveling load is large, such as when the vehicle is traveling at higher speed, the ambient temperature is high, and the operating load of a battery cooling device for cooling the battery is large, the battery temperature may reach the workable upper limit temperature even if the output restriction is performed.

### SUMMARY

An automotive battery system according to the present disclosure includes a battery mounted on a vehicle to supply electric power to an electric motor that drives the vehicle, a battery cooling device for cooling the battery, a battery temperature sensor for detection of battery temperature, an ambient temperature sensor for detection of ambient temperature, a traveling load acquisition device for acquisition of traveling load of the vehicle, a cooling load acquisition device for acquisition of operating load of the battery cooling device, and a battery control device for controlling input/output power of the battery and limiting the electric power output from the battery when the battery temperature is equal to or higher than a predetermined power restrictive lower limit temperature. The power restrictive lower limit temperature is a first power restrictive lower limit temperature when not fulfilling at least one of three conditions of: the ambient temperature is equal to or higher than a predetermined temperature; the traveling load of the vehicle is equal to or greater than a predetermined traveling load; and the operating load of the battery cooling device is equal to or greater than a predetermined operating load, and the power restrictive lower limit temperature is a second power restrictive lower limit temperature, which is lower than the first power restrictive lower limit temperature, upon fulfillment of each of the three conditions.

In a situation where the temperature of the battery tends to rise, starting suppression of the heat generation amount of the battery at earlier stage where the battery temperature is lower can prevent the battery temperature from reaching the workable upper limit temperature. In addition, when the operating load of the battery cooling device is small and the cooling power has a sufficient margin, the output restriction for the battery is not performed. As a result, it is possible to suppress the frequency of the output restriction.

Further, in the above-described automotive battery system, the battery cooling device may include a liquid cooling device that cools the battery with cooling liquid that circulates in the battery and a heat exchanger, and a refrigeration cycle device that cools the cooling liquid of the liquid cooling device, with refrigerant of refrigeration cycle, via the heat exchanger. Configuring the battery cooling device by combining the liquid cooling device and the refrigeration cycle device can cool the battery efficiently and strongly.

Further, in the above-described automotive battery system, the cooling load acquisition device may acquire the operating load of the battery cooling device based on at least either the flow rate of the cooling liquid of the liquid cooling device or the rotational speed of a compressor that compresses the refrigerant of the refrigeration cycle device.

Further, in the above-described automotive battery system, the refrigeration cycle device may be an air conditioning device that air-conditions a passenger compartment of the vehicle. Partially using the battery cooling device as the air conditioning device for the passenger compartment can downsize the entire device and realize easy mounting to the vehicle. In addition, acquiring the operating load of the battery cooling device based on the rotational speed of the compressor can perform the output restriction for the battery at a lower temperature, when the battery cooling device is operating at a high-load condition due to the cooling for the passenger compartment.

Further, in the above-described automotive battery system, the traveling load acquisition device may include a vehicle speed sensor for detection of traveling speed of the vehicle, and may calculate the traveling load of the vehicle based on the detected traveling speed of the vehicle. When the vehicle traveling speed is high, the heat generation amount of the battery becomes larger. Limiting the output power of the battery can suppress the temperature rise of the battery.

Further, in the above-described automotive battery system, the traveling load acquisition device may include an accelerator sensor for detection of operation amount of an accelerator operator and may calculate the traveling load of the vehicle based on the detected operation amount of the accelerator operator. When the accelerator operation amount is large, the heat generation amount of the battery becomes larger. Limiting the output power of the battery can suppress the temperature rise of the battery.

Furthermore, in the above-described automotive battery system, the traveling load acquisition device may include a vehicle speed sensor for detection of traveling speed of the vehicle and an accelerator sensor for detection of operation amount of the accelerator operator, and may calculate the traveling load of the vehicle based on the detected traveling speed of the vehicle and the detected operation amount of the accelerator operator. Calculating the traveling load of the vehicle based on both the traveling speed of the vehicle and the accelerator operation amount can accurately calculate the traveling load.

Further, in the above-described automotive battery system, when the above three conditions are fulfilled, the battery control device may set the output power to be equal to or less than an output power in a case where at least one of the three conditions is not fulfilled, in a temperature range in which the battery temperature is equal to or higher than the second power restrictive lower limit temperature.

Further, in the above-described automotive battery system, when the three conditions are fulfilled, the battery control device may continuously reduce the output power with rising battery temperature in a temperature range in which the battery temperature is equal to or higher than the second power restrictive lower limit temperature. It is possible to suppress a sudden drop in the driving force of the vehicle due to the temperature rise of the battery.

According to the present disclosure, in a state where the battery temperature tends to rise more than usual, it is possible to suppress the temperature rise of the battery and prevent the battery temperature from exceeding the workable upper limit temperature.

### BRIEF DESCRIPTION OF DRAWINGS

An embodiment of the present disclosure will be described based on the following figures, wherein:

FIG. 1 is a diagram illustrating a schematic configuration of an automotive battery system of an embodiment;

FIG. 2 is a diagram illustrating characteristics of output power of the battery; and

FIG. 3 is a flowchart illustrating a control flow relating to output restriction for the battery.

### DESCRIPTION OF EMBODIMENT

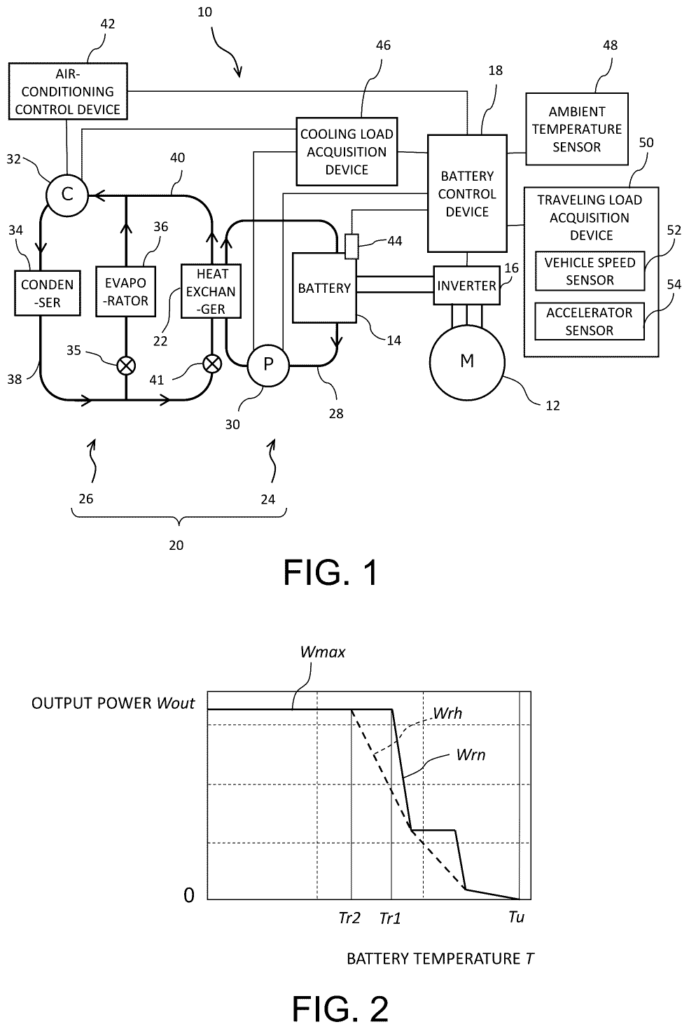

Hereinafter, an embodiment of the present disclosure will be described with reference to attached drawings. FIG. 1 is a diagram illustrating a schematic configuration of a battery system 10 of the present embodiment, which is mounted on a vehicle. FIG. 1 illustrates an electric motor 12, to which electric power is supplied from the battery system 10, for driving of the vehicle. Hereinafter, the electric motor is simply referred to as motor. The motor 12 also functions as a power generator while the vehicle is in a deceleration state. The vehicle may be a battery electric vehicle that is driven by an electric motor only, or may be a hybrid electric vehicle that is driven by a combination of an electric motor and an engine.

The battery system 10 includes a battery 14. Electric power discharged from the battery 14 is supplied, via an inverter 16, to the motor 12. Electric power generated by the motor 12 charges the battery 14 via the inverter 16. The battery system 10 includes a battery control device 18. The battery control device 18 is for controlling the inverter 16 to control the electric power supplied to the motor 12 and the electric power regenerated from the motor 12.

The battery system 10 includes a battery cooling device 20 that cools the battery 14. The battery cooling device 20 includes a liquid cooling device 24 that cools the battery 14 with cooling liquid circulating in the battery 14 and a heat exchanger 22, and a refrigeration cycle device 26 that cools the cooling liquid in the liquid cooling device 24, with refrigerant of refrigeration cycle, via the heat exchanger 22.

The liquid cooling device 24 includes a cooling liquid passage 28 that connects the battery 14 and the heat exchanger 22 in annular manner so that the cooling liquid can flow, and a cooling liquid pump 30 provided on the cooling liquid passage 28 to circulate the cooling liquid. The cooling liquid pump 30 is an electric pump, and its rotational speed is controlled by the battery control device 18. Controlling the rotational speed of the cooling liquid pump 30 makes it possible to change the flow rate of the cooling liquid flowing in the cooling liquid passage 28. Further, in a case where a pump motor that drives the cooling liquid pump 30 is a PWM-controlled electric motor, controlling the duty ratio of electric power to be supplied to the pump motor makes it possible to change the rotational speed of the cooling liquid pump 30.

The refrigeration cycle device 26 includes a compressor 32 that compresses the refrigerant, a condenser 34 that condenses the compressed refrigerant, an evaporator 36 that evaporates the condensed refrigerant passed through an expansion valve 35, and an annular refrigerant passage 38 that connects these members in annular so that the refrigerant can flow. Further, in addition to the annular refrigerant passage 38, the refrigeration cycle device 26 includes a bypass refrigerant passage 40 that is provided so as to bypass the evaporator 36. The bypass refrigerant passage 40 is provided with an expansion valve 41 and the heat exchanger 22 of the liquid cooling device 24, which is positioned on the downstream side of the expansion valve 41. In the heat exchanger 22, the cooling liquid of the liquid cooling device 24 is cooled by the refrigerant of the refrigeration cycle device 26. The refrigeration cycle device 26 may be an air conditioning device that air-conditions a passenger compartment (not illustrated) of the vehicle. When air is supplied to the surroundings of the evaporator 36, the air is cooled and the cooled air is supplied to the passenger compartment so that the passenger compartment can be air-conditioned. An air-conditioning control device 42 controls the rotational speed of the compressor 32. The rotational speed control makes it possible to adjust the air-conditioning power for the passenger compartment and the cooling power of the cooling liquid in the heat exchanger 22.

The battery control device 18 manages the temperature of the battery 14. The battery 14 is equipped with a battery temperature sensor 44 that detects the temperature of the battery 14. The battery control device 18 controls the battery cooling device 20 based on the battery temperature detected by the battery temperature sensor 44. When the battery temperature rises, the battery control device 18 increases the rotational speed of the cooling liquid pump 30, thereby increasing the flow rate of the cooling liquid and accordingly increasing the cooling power of the liquid cooling device 24. In addition, if necessary, the battery control device 18 causes the air-conditioning control device 42 to increase the rotational speed of the compressor 32, thereby increasing the cooling power of the refrigeration cycle device 26. Increasing the cooling power of the refrigeration cycle device 26 enables the heat exchanger 22 to further cool the cooling liquid.

The battery control device 18 controls, based on the detected battery temperature, electric power to be output from the battery 14 and electric power to be input to the battery 14. Specifically, the battery control device 18 controls the inverter 16 so as to adjust the input/output power of the battery 14. When the battery temperature exceeds the workable upper limit temperature of the battery 14, the battery control device 18 stops using the battery 14. In order to prevent the battery 14 from becoming unusable when the battery temperature rises, the battery control device 18 limits the input/output power of the battery 14 when the battery temperature comes close to the workable upper limit temperature, thereby suppressing the battery temperature rise.

The battery system 10 includes a cooling load acquisition device 46 that acquires the current cooling power of the battery cooling device 20; namely, the operating load relating to cooling (hereinafter, referred to as cooling load). The cooling load acquisition device 46 acquires the cooling load based on at least either the flow rate of cooling water in the liquid cooling device 24 or the rotational speed of the compressor 32 in the refrigeration cycle device 26. When the flow rate of the cooling water in the liquid cooling device 24 is high, it is conceived that the battery 14 is in a state where more cooling is required, and accordingly, in a state where the cooling load is high. On the other hand, when the rotational speed of the compressor 32 is high, it is conceived that the cooling water of the liquid cooling device 24 is in a state where more cooling is required, and accordingly, in a state where the cooling load is high. Further, in the case where the refrigeration cycle device 26 serves as the air conditioning device for the passenger compartment, when the rotational speed of the compressor 32 is high, the temperature in the passenger compartment is high and therefore in this case the cooling load of the refrigeration cycle device 26 is high.

The cooling load acquisition device 46 may calculate the flow rate of the cooling liquid in the liquid cooling device 24 from the rotational speed of the cooling liquid pump 30. A rotational speed sensor for detection of the rotational speed of the cooling liquid pump 30 or a rotary portion of the pump motor that drives the cooling liquid pump 30 may be provided to detect the rotational speed of the cooling liquid pump 30. Alternatively, the rotational speed of the cooling liquid pump 30 may be acquired based on the current supplied to the pump motor that drives the cooling liquid pump 30. For example, when the pump motor is PWM-controlled, it is possible to acquire the rotational speed of the cooling liquid pump 30 based on the duty ratio of the current. Alternatively, the rotational speed of the cooling liquid pump 30 may be calculated based on a control command of the battery control device 18 that controls the cooling liquid pump 30. Alternatively, the cooling liquid passage 28 may be equipped with a flowmeter, so that the flow rate of the cooling liquid in the liquid cooling device 24 can be acquired by this flowmeter.

The cooling load acquisition device 46 may acquire the rotational speed of the compressor 32 from a rotational speed sensor that detects the rotational speed of a rotary portion of the compressor 32. Alternatively, the rotational speed of the compressor 32 may be acquired based on a control command for the compressor 32 of the air-conditioning control device 42.

The battery system 10 includes an ambient temperature sensor 48 that detects the outside air temperature of the vehicle. The battery control device 18 controls the cooling power of the battery cooling device 20 based on the ambient temperature detected by the ambient temperature sensor 48. When the ambient temperature is high, the battery temperature tends to rise and therefore the battery control device 18 increases the cooling power of the battery cooling device 20.

The battery system 10 includes a traveling load acquisition device 50 that acquires the traveling load of the vehicle. The traveling load acquisition device 50 includes at least either a vehicle speed sensor 52 that detects the traveling speed of the vehicle or an accelerator sensor 54 that detects an operation amount of an operator such as an accelerator pedal that is operated by a driver. The traveling load acquisition device 50 determines that the traveling load is large when the vehicle traveling speed is high. and also determines that the traveling load is large when the accelerator operation amount is large. Alternatively, it may be useful to determine the traveling load for a combination of the vehicle traveling speed and the accelerator operation amount. For example, when the accelerator operation amount is large even though the vehicle traveling speed is low, it is assumed that the traveling load is large, for example, because the vehicle is traveling on an uphill road or the vehicle is towing a trailer.

The battery control device 18 includes a processing device that runs a predetermined program to perform information processing. The cooling load acquisition device 46 may include sensors that convert physical quantities such as the flow rate and the rotational speed into electric signals, and a processing device that calculates the cooling load based on the electric signals of these sensors. The traveling load acquisition device 50 may include sensors that convert into electric signals physical quantities such as the traveling speed of the vehicle and the accelerator operation amount, and a processing device that calculates the traveling load based on the electric signals of these sensors. The processing devices of the battery control device 18, the cooling load acquisition device 46, and the traveling load acquisition device 50 may be implemented by a single processing device that runs a program corresponding to these devices.

FIG. 2 is a diagram illustrating a relationship between battery temperature T and output power Wout of the battery 14. The output power Wout of the battery 14 is controlled, in a range in which the battery temperature T is not high, to be equal to or less than a constant upper limit value Wmax. In a range in which the battery temperature T is high, the output power Wout of the battery 14 is controlled to be equal to or less than an output limiting value Wrn, Wrh, which is lower than the upper limit value Wmax. When the battery temperature T is equal to or higher than a workable upper limit temperature Tu, the output power Wout of the battery 14 is set to be 0. As the battery temperature T rises, the battery control device 18 limits the output power Wout before reaching the workable upper limit temperature Tu, thereby suppressing the temperature rise. When the battery temperature T reaches power restrictive a lower limit temperatures Tr1, Tr2; i.e., the lower limit value Tr1, Tr2 in the temperature range in which the output restriction is performed, the battery control device 18 applies the output limiting value Wrn, Wrh so that the output power Wout is controlled to be equal to or less than the output limiting value Wrn, Wrh. The battery control device 18 selects one of these output limiting values Wrn and Wrh depending on the traveling load, the ambient temperature, and the cooling load; i.e., the operating load of the battery cooling device 20 during cooling. When the traveling load is large, the ambient temperature is high, and the cooling load is large, the battery temperature may abruptly rise. In such a case, the battery control device 18 selects the output limiting value Wrh, which is more suppressed than the output limiting value Wrn applied in the normal condition. Hereinafter, the output limiting value Wrn is referred to as normal output limiting value Wrn, and the output limiting value Wrh is referred to as high-load output limiting value Wrh.

When the battery temperature T is equal to or higher than the first power restrictive lower limit temperature Tr1, the battery control device 18 performs the output restriction for the normal condition in which the normal output limiting value Wrn decreases stepwise from the first power restrictive lower limit temperature Tr1 toward the workable upper limit temperature Tu. Further, the normal output limiting value Wrn changes with a great inclination in a region connecting flat portions different in level. Therefore, when the output restriction for the normal condition is performed in a situation where the output power Wout is large, the output power Wout may drop abruptly.

The battery control device 18 applies the high-load output limiting value Wrh in the high load condition in which the battery temperature T may abruptly rise, as described above. The battery control device 18 performs the output restriction for the high load condition when the battery temperature T is equal to or higher than the second power restrictive lower limit temperature Tr2, which is lower than the first power restrictive lower limit temperature Tr1. The high-load output limiting value Wrh continuously decreases toward the workable upper limit temperature Tu, without any flatly level portion, with rising battery temperature T Further, in the temperature range equal to or higher than the second power restrictive lower limit temperature Tr2, the high-load output limiting value Wrh is equal to or less than the upper limit value Wmax of the output power and also the normal output limiting value Wrn. Performing the output restriction even when the battery temperature T is lower than the normal value makes it possible to suppress the output power Wout at the earlier stage in the process in which the battery temperature T rises, thereby preventing the battery temperature T from reaching the workable upper limit temperature Tu. In addition, since the high-load output limiting value Wrh gradually decreases with rising battery temperature T, it is possible to prevent the output power Wout from dropping abruptly.

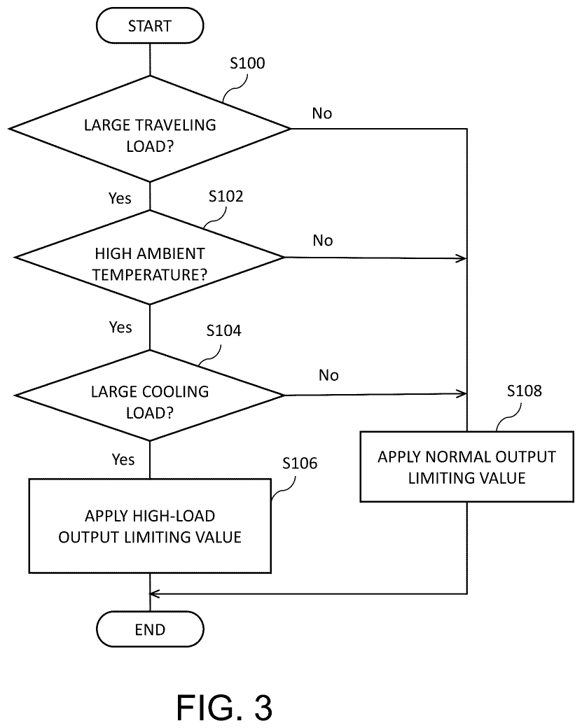

FIG. 3 is a flowchart relating to the restriction of electric power output from the battery 14. First, in step S100, the battery control device 18 determines whether the traveling load is large. The traveling load can be acquired based on at least either the vehicle traveling speed or the accelerator operation amount. When the vehicle traveling speed is high, the output of the motor 12 is large because it is necessary to resist the running resistance, and accordingly the output power Wout of the battery 14 is large correspondingly. Therefore, the heat generation amount of the battery 14 increases. Further, when the accelerator operation amount is large, it is conceived that the driver requires a large output from the motor 12, the output power Wout of the battery 14 becomes larger, and the heat generation amount of the battery 14 increases correspondingly. Acquiring the traveling load based on both of the vehicle traveling speed and the accelerator operation amount makes it possible to perform more precise determination. Even when the vehicle traveling speed is low, a large driving force is required in a situation where the vehicle is traveling on an uphill road or towing a trailer. Therefore, the driver depresses the accelerator pedal and the accelerator operation amount increases. Then, the output of the motor 12 becomes larger and the heat generation amount of the battery 14 increases correspondingly. In this case, even when the vehicle traveling speed is low, it is desirable to apply the high-load output limiting value Wrh. For example, when the vehicle traveling speed is equal to or higher than 140 km/h, the battery control device 18 determines that the traveling load is large. Further, for example, when the accelerator operation amount is equal to or greater than a level of 5/8, the battery control device 18 determines that the traveling load is large. When the traveling load is small (No in step S100), then in step S108, the battery control device 18 applies the normal output limiting value Wrn.

If it is determined that the traveling load is large (Yes in step S100), then in step S102 the battery control device 18 determines whether the ambient temperature is high. When the ambient temperature is high, the temperature around the battery 14 is also high, and therefore the amount of heat radiated from the battery 14 to the atmosphere is small, and the battery temperature tends to rise. For example, when the ambient temperature is equal to or higher than 40° C., the battery control device 18 determines that the ambient temperature is high. If the ambient temperature is low (No in step S102), then in step S108, the battery control device 18 applies the normal output limiting value Wrn.

If it is determined that the ambient temperature is high (Yes in step S102), then in step S104 the battery control device 18 determines whether the cooling load (the operating load relating to the cooling of the battery cooling device 20) is large. The cooling load can be determined based on at least either the flow rate of the cooling liquid in the liquid cooling device 24 or the rotational speed of the compressor 32 in the refrigeration cycle device 26. When the flow rate of the cooling liquid is equal to or higher than a predetermined value, or when the rotational speed of the compressor 32 is equal to or higher than a predetermined value, the battery control device 18 determines that the cooling load is large. Specifically, for example, when the flow rate of the cooling liquid is equal to or higher than 60% in terms of the duty ratio of the current for driving the pump motor of the cooling liquid pump 30 (the maximum value of the duty ratio is 85%), the battery control device 18 determines that the cooling load is large. Alternatively, for example, when the rotational speed of the compressor 32 is equal to or higher than 60% of the maximum speed, the battery control device 18 determines that the cooling load is large. When the flow rate of the cooling liquid is high, there is little margin to increase the flow rate, and when the battery temperature rises further, there is little surplus power to deal with this. When the rotational speed of the compressor 32 is high, the surplus power of the refrigeration cycle device 26 corresponding to a further rise in battery temperature is small. Accordingly, when the flow rate of the cooling liquid is high and the rotational speed of the compressor 32 is high, the cooling power of the battery cooling device 20 has little margin. In this case, it is desirable to apply the high-load output limiting value Wrh.

In a case where the refrigeration cycle device 26 serves as the air conditioning device that air-conditions the passenger compartment or the like, the rotational speed of the compressor 32 may increase due to the temperature of the passenger compartment or the like and the cooling demand based on the passenger's request. When the rotational speed of the compressor 32 is high due to the cooling demand for the passenger compartment or the like; namely, when the cooling load of the refrigeration cycle device 26 is high, even if there is a cooling demand for the battery 14, there is less surplus power to meet this demand. Accordingly, even in such a case, it is desirable to apply the high-load output limiting value Wrh. If the cooling load of the battery cooling device 20 is small (No in step S104), then in step S108 the battery control device 18 applies the normal output limiting value Wrn. If the cooling load is large (Yes in step S104), then in step S106 the battery control device 18 applies the high-load output limiting value Wrh.

Starting the output restriction at an earlier stage than usual in the process that the temperature of the battery 14 rises; namely when the battery temperature is low, under the condition that the battery temperature tends to rise, can prevent the battery temperature T from reaching the workable upper limit temperature Tu. In addition, when the cooling power of the battery cooling device 20 has a sufficient margin, the possibility that the output restriction is frequently performed can be reduced by applying the output restriction for the normal condition.

1. An automotive battery system comprising:
a battery mounted on a vehicle to supply electric power to an electric motor that drives the vehicle;
a battery cooling device for cooling of the battery;
a battery temperature sensor for detection of battery temperature;
an ambient temperature sensor for detection of ambient temperature;
a traveling load acquisition device for acquisition of traveling load of the vehicle;
a cooling load acquisition device for acquisition of operating load of the battery cooling device; and
a battery control device for controlling input/output power of the battery and limiting electric power output from the battery when the battery temperature is equal to or higher than a predetermined power restrictive lower limit temperature,
wherein
the power restrictive lower limit temperature is a first power restrictive lower limit temperature when not fulfilling at least one of three conditions of:
the ambient temperature is equal to or higher than a predetermined temperature;
the traveling load of the vehicle is equal to or greater than a predetermined traveling load; and
the operating load of the battery cooling device is equal to or greater than a predetermined operating load,
and the power restrictive lower limit temperature is a second power restrictive lower limit temperature, which is lower than the first power restrictive lower limit temperature, upon fulfillment of each of the three conditions.

2. The automotive battery system according to claim 1, in which the battery cooling device includes a liquid cooling device that cools the battery with cooling liquid that circulates in the battery and a heat exchanger, and a refrigeration cycle device that cools the cooling liquid of the liquid cooling device, with refrigerant of refrigeration cycle, via the heat exchanger.

3. The automotive battery system according to claim 2, in which the cooling load acquisition device acquires the operating load of the battery cooling device based on at least either the flow rate of the cooling liquid of the liquid cooling device or the rotational speed of a compressor that compresses the refrigerant of the refrigeration cycle device.

4. The automotive battery system according to claim 2, in which the refrigeration cycle device is an air conditioning device that air-conditions a passenger compartment of the vehicle.

5. The automotive battery system according to claim 1, in which the traveling load acquisition device includes a vehicle speed sensor for detection of traveling speed of the vehicle, and calculates the traveling load of the vehicle based on the detected traveling speed of the vehicle.

6. The automotive battery system according to claim 1, in which the traveling load acquisition device includes an accelerator sensor for detection of operation amount of an accelerator operator, and calculates the traveling load of the vehicle based on the detected operation amount of the accelerator operator.

7. The automotive battery system according to claim 1, in which the traveling load acquisition device includes a vehicle speed sensor for detection of traveling speed of the vehicle, and an accelerator sensor for detection of operation amount of the accelerator operator, and calculates the traveling load of the vehicle based on the detected traveling speed of the vehicle and the detected operation amount of the accelerator operator.

8. The automotive battery system according to claim 1, in which when the three conditions are fulfilled, the battery control device sets the output power to be equal to or less than an output power in a case where at least one of the three conditions is not fulfilled, in a temperature range in which the battery temperature is equal to or higher than the second power restrictive lower limit temperature.

9. The automotive battery system according to claim 8, in which when the three conditions are fulfilled, the battery control device continuously reduces the output power with rising battery temperature in a temperature range in which the battery temperature is equal to or higher than the second power restrictive lower limit temperature.
